(19) United States
(12) Patent Application Publication
(10) Pub. No.: US 2020/0037190 A1
(43) Pub. Date: Jan. 30, 2020

(54) METHODS AND APPARATUS FOR QOS SUPPORT FOR SIDELINK IN NETWORK SCHEDULED MODE

(71) Applicant: QUALCOMM Incorporated, San Diego, CA (US)

(72) Inventors: Zhibin WU, Sunnyvale, CA (US); Hong CHENG, Bridgewater, NJ (US); Kapil GULATI, Hillsborough, NJ (US); Sudhir Kumar BAGHEL, Hillsborough, NJ (US); Shailesh PATIL, San Diego, CA (US)

(21) Appl. No.: 16/522,402

(22) Filed: Jul. 25, 2019

Related U.S. Application Data
(60) Provisional application No. 62/711,922, filed on Jul. 30, 2018.

(51) Int. Cl. H04W 24/10; H04W 28/02

(52) U.S. Cl. CPC H04W 24/10; H04W 92/18; H04W 28/0278

(57) ABSTRACT

An aspect of the present disclosure includes methods, systems, and non-transitory computer-readable media for receiving a QoS profile from a source UE, receiving at least one of source UE information or destination UE information from the source UE, identifying RRC information for a direct communication link between the source UE and a destination UE based on at least one of the QoS profile, the source UE information, and the destination UE information, and transmitting the RRC information to the source UE.

### CROSS REFERENCE TO RELATED APPLICATIONS

The present application claims priority to U.S. Provisional Application No. 62/711,922, filed on Jul. 30, 2018, entitled “Methods and Apparatus for QoS Support For Sidelink In Network Scheduled Mode,” the contents of which are incorporated by reference in their entireties.

### BACKGROUND

Aspects of the present disclosure relate generally to wireless communication networks, and more particularly, to apparatus and methods for vehicle-to-everything (V2X) communication, such as vehicle-to-vehicle (V2V) communication.

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which may be referred to as new radio (NR)) is envisaged to expand and support diverse usage scenarios and applications with respect to current mobile network generations. In an aspect, 5G communications technology may include: enhanced mobile broadband addressing human-centric use cases for access to multimedia content, services and data; ultra-reliable-low latency communications (URLLC) with certain specifications for latency and reliability; and massive machine type communications, which may allow a very large number of connected devices and transmission of a relatively low volume of non-delay-sensitive information. As the demand for mobile broadband access continues to increase, however, further improvements in NR communications technology and beyond may be desired.

When utilizing V2V communication, a user equipment (UE) may communicate directly with other UEs via NR wireless communication technology. The radio resources used by the UEs may be allocated by a NR base station (BS), also known as a gNB. However, in the current LTE V2V, the UE indicates Proximity Service (ProSe) Per Packet Priority (PPPP) and ProSe Per Packet Reliability (PPPR) associations with a destination identification (ID) to the radio access network (RAN). The RAN, in turn, schedules traffic by deriving PPPP/PPPR from the destination ID included in a buffer status report sent by the UE. However, this scheme does not work for NR sidelink/V2V due to the new Quality of Service (QoS) model (new parameters and support of unicast). In NR sidelink/V2V, the new QoS model is based on 5G QoS. In addition, the grant in physical downlink data channel (PDDCH) for LTE V2V may be ambiguous and does not support NR model because the grant does not contain any information about the destination ID. Consequently, it may be difficult to tell whether the grant is for unicast, multicast, or broadcast. Therefore, improvements in V2V communication may be desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure include methods for receiving a QoS profile from a source UE, receiving at least one of source UE information or destination UE information from the source UE, identifying RRC information for a direct communication link between the source UE and a destination UE based on at least one of the QoS profile, the source UE information, and the destination UE information, and transmitting the RRC information to the source UE.

Some aspects of the present disclosure include apparatuses having a memory configured to store instructions, a transceiver, and one or more processors communicatively coupled with the memory and the transceiver, wherein the one or more processors may be configured to execute the instructions to perform the steps of receiving a QoS profile from a source UE, receiving at least one of source UE information or destination UE information from the source UE, identifying RRC information for a direct communication link between the source UE and a destination UE based on at least one of the QoS profile, the source UE information, and the destination UE information, and transmitting the RRC information to the source UE.

Certain aspects of the present disclosure include a non-transitory computer-readable medium having instructions stored therein that, when executed by one or more processors, cause the one or more processors to perform the steps of receiving a QoS profile from a source UE, receiving at least one of source UE information or destination UE information from the source UE, identifying RRC information for a direct communication link between the source UE and a destination UE based on at least one of the QoS profile, the source UE information, and the destination UE information, and transmitting the RRC information to the source UE.

Some aspects of the present disclosure include means for receiving a QoS profile from a source UE, means for receiving at least one of source UE information or destination UE information from the source UE, means for identifying RRC information for a direct communication link between the source UE and a destination UE based on at least one of the QoS profile, the source UE information, and the destination UE information, and means for transmitting the RRC information to the source UE.

Aspects of the present disclosure include methods for transmitting a QoS profile to a BS, transmitting at least one of source UE information or destination UE information to the BS, and receiving the RRC information from the BS.

Some aspects of the present disclosure include apparatuses having a memory configured to store instructions, a transceiver, and one or more processors communicatively coupled with the memory and the transceiver, wherein the one or more processors may be configured to execute the instructions to perform the steps of transmitting a QoS profile to a BS, transmitting at least one of source UE information or destination UE information to the BS, and receiving the RRC information from the BS.

Certain aspects of the present disclosure include a non-transitory computer-readable medium having instructions stored therein that, when executed by one or more processors, cause the one or more processors to perform the steps of transmitting a QoS profile to a BS, transmitting at least one of source UE information or destination UE information to the BS, and receiving the RRC information from the BS.

Some aspects of the present disclosure include means for transmitting a QoS profile to a BS, means for transmitting at least one of source UE information or destination UE information to the BS, and means for receiving the RRC information from the BS.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and the description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example of a wireless communication network;

FIG. 2 is a schematic diagram of an example of a user equipment;

FIG. 3 is a schematic diagram of an example of a base station;

FIG. 4 is an example of a wireless communication network for enhanced layer 3 (L3) radio resource control signaling;

FIG. 5 is examples of buffer status reports;

FIG. 6 is a process flow diagram of an example of a method for allocating RRC resource; and

FIG. 7 is a process flow diagram of an example of a method for receiving RRC information.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout the disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium, such as a computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 902.11 (Wi-Fi), IEEE 902.16 (WiMAX), IEEE 902.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A and/or 5G New Radio (NR) system for purposes of example, and LTE or 5G NR terminology is used in much of the description below, although the techniques are applicable beyond LTE/LTE-A and 5G NR applications, e.g., to other next generation communication systems).

A 5G V2V UE (hereinafter referred to as “UE”) may support both Long Term Evolution (LTE) V2V and NR V2V radio. The network may configure the UE to use Mode 3 operation (i.e. scheduled resource allocation). For NR PC5 Mode 3 operation, three components may be used: radio resource control (RRC) for the sidelink configuration of NR PC5 operation parameters and resources, media access control (MAC), such as buffer status report (BSR) for UE's scheduling request, and downlink control information (DCI-5) to indicate the scheduling assignment (SA) resource locations.

In NR Sidelink/V2V design, new QoS Model was introduced based on 5G QoS. For example, for broadcast traffic, 5G QoS Indicator (5QI) may be used instead of PPPP. For unicast or multicast traffic, bearers like QoS configuration may be used in lieu of per packet priority handling. When NR Sidelink/V2V works in network-scheduled mode (Mode 3), resources are allocated by RAN node (e.g., eNB/gNB), even if the traffic does not pass through the RAN.

RAN may bind a QoS Profile to a particular sidelink bearer of communication pairs (i.e., source and destination UEs). A communication pair (source and destination UEs) may be identified with <SRC, DST> identifiers. For two UEs with the same <SRC, DST>, but with multiple sidelink bearers between them, a bearer ID may be used to identify the bearer, and therefore, the QoS. A bearer ID may be controlled and generated by the UE itself. A source UE, for example, may also choose different layer-2 (L2) IDs for different services (e.g., provider service identification (PSID)), without using a bearer ID. The source UE may signal information relating to the peer UE (e.g., DST L2 ID) and the QoS profile to the RAN. Sidelink scheduling grant is enhanced to indicate information of communication pair or target (DST address), also the bearer information.

The source UE generates RRC signaling toward RAN to provide information about QoS profile (e.g., kind of 5QI value UE expects for the V2V service requested), both SRC and DST L2 IDs used for unicast communication, and bearer ID. The DST L2 ID may be mapped to a destination index. The size of destination index may be increased to accommodate a large variety of traffic sent by the same source UE (e.g., from 16 to 32 or 64). In some examples, the reporting may be implemented using existing RRC message, such as SideUEInformation.

Mapping between the sidelink bearer and logical channel group (LCG) may be provided, based on respective QoS requirements. Dedicated Radio Network Temporary Identifier (RNTI) for the V2V unicast may be provided for each destination. Optionally, a Link ID for the SRC-DST pair may be allocated by the eNB/gNB to represent this unicast connection. The Link ID may be reused by the SRC or DST UE for ensuing RRC requests to identify this context. In certain implementations, the existing RRC signaling RRC ConnectionReconfiguration may be used. The mapping and the linked ID may be changed when the L2 ID changes (e.g., UE generates temporary L2 IDs for unicast communication).

During the media access control signaling (e.g., resource request), the NR buffer status report (BSR) may be enhanced by associating the request of resource with the communication pair identifier, <SRC, DST> IDs, and the bearer ID. In some examples, the BSR format may include a destination index (e.g., 5 bits), a LCG ID (e.g., 3 bits), and the buffer size (e.g., 8 bits). For NR sidelink BSR, multiple 2-octet reports may be augmented to represent all LCGs which has data available.

The sidelink grant may indicate the communication pair (i.e., <SRC, DST> IDs) and the bearer or the bearer group (i.e., bearer ID) in the grant so the SRC UE may ensure QoS. The DCI format may be enhanced to convey sidelink grant for unicast. In one example, the message may be scrambled with the dedicated RNTI allocated for a particular <SRC DST> communication pair. In another example, the communication pair IDs and the bearer ID allocated for unicast may be included as part of the grant. While the examples below illustrate V2V communications, aspects of the present disclosure may be applied to V2X communications.

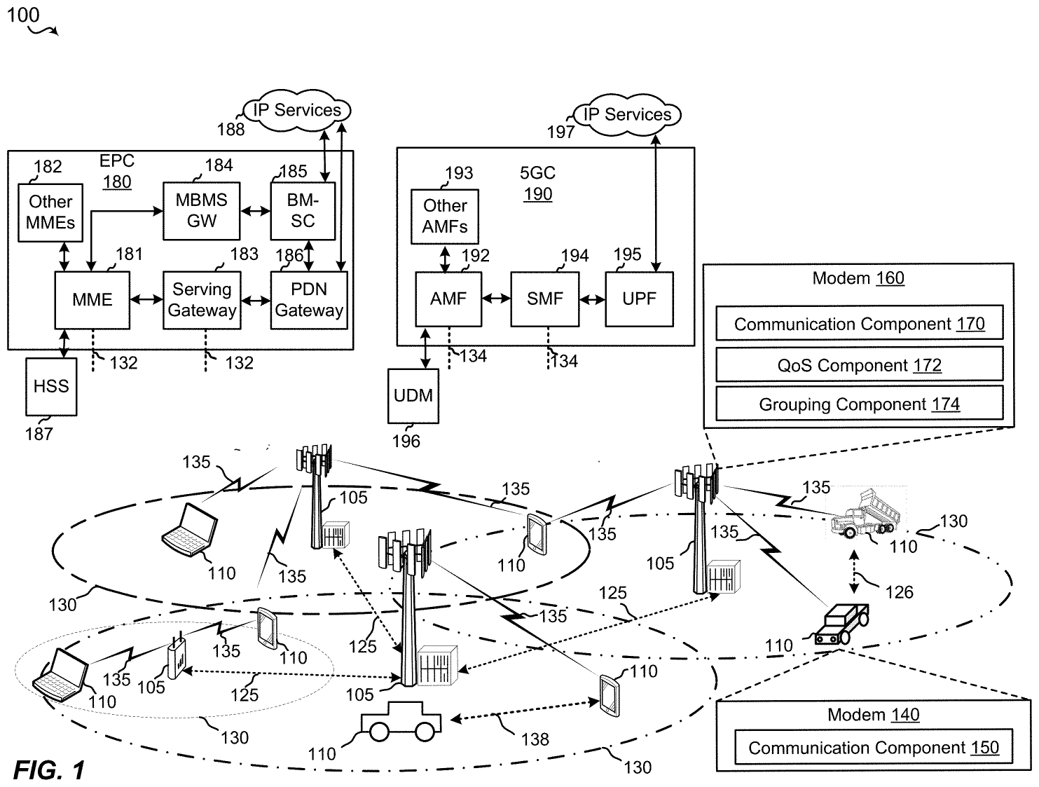

Referring to FIG. 1, in accordance with various aspects of the present disclosure, a wireless communication network 100 includes at least one UE 110 including a modem 140. The modem 140 may include a communication component 150 configured to communicate with the other UEs 110 and/or base stations 105, such as sending/receiving messages to the other UEs 110 and/or base stations 105.

The wireless network may include at least one base station 105 including a modem 160. The modem 160 may include a communication component 170 configured to communicate with one or more UEs 110 and/or other base stations 105, such as sending/receiving messages to the UEs 110 and/or other base stations 105. The modem 160 may include a QoS component 172 that determines the quality of service and identifiers associated with the QoS for sidelink communications among UEs. The modem 160 may include a grouping component 174 that manages the indices and logical groups of the L2IDs, the Link IDs, and the logical channel group IDs.

The modem 160 of a base station 105 may be configured to communicate with other base stations 105 and UEs 110 via a cellular network, a Wi-Fi network, or other wireless and wired networks. The modem 140 of a UE 110 may be configured to communicate with the base stations 105 via a cellular network, a Wi-Fi network, or other wireless and wired networks. The modems 140, 160 may receive and transmit data packets.

The wireless communication network 100 may include one or more base stations 105, one or more UEs 110, and a core network, such as an Evolved Packet Core (EPC) 180 and/or a 5G core (5GC) 190. The EPC 180 and/or the 5GC 190 may provide user authentication, access authorization, tracking, internet protocol (IP) connectivity, and other access, routing, or mobility functions. The base stations 105 configured for 4G LTE (collectively referred to as Evolved Universal Mobile Telecommunications System (UMTS) Terrestrial Radio Access Network (E-UTRAN)) may interface with the EPC 180 through backhaul links 132 (e.g., S1, etc.). The base stations 105 configured for 5G NR (collectively referred to as Next Generation RAN (NG-RAN)) may interface with the 5GC 190 through backhaul links 134. In addition to other functions, the base stations 105 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 105 may communicate with each other directly or indirectly (e.g., through the EPC 180 or the 5GC 190), with one another over backhaul links 125, 132, or 134 (e.g., Xn, X1, or X2 interfaces). The backhaul links 125, 132, 134 may be wired or wireless communication links.

The base stations 105 may wirelessly communicate with the UEs 110 via one or more antennas. Each of the base stations 105 may provide communication coverage for a respective geographic coverage area 130. In some examples, the base stations 105 may be referred to as a base station, a radio base station, an access point (AP), an access node, a radio transceiver, a NodeB, eNodeB (eNB), gNodeB (gNB), Home NodeB, a Home eNodeB, a relay, a transceiver function, a basic service set (BSS), an extended service set (ESS), a transmit reception point (TRP), or some other suitable terminology. The geographic coverage area 130 for a base station 105 may be divided into sectors or cells making up only a portion of the coverage area (not shown). The wireless communication network 100 may include base stations 105 of different types (e.g., macro cell base stations or small cell base stations, described below). Additionally, the plurality of base stations 105 may operate according to different ones of a plurality of communication technologies (e.g., 5G (New Radio or “NR”), fourth generation (4G)/LTE, 3G, Wi-Fi, Bluetooth, etc.), and thus there may be overlapping geographic coverage areas 130 for different communication technologies.

In some examples, the wireless communication network 100 may be or include one or any combination of communication technologies, including a NR or 5G technology, a LTE or LTE-Advanced (LTE-A) or MuLTEfire technology, a Wi-Fi technology, a Bluetooth technology, or any other long or short range wireless communication technology. In LTE/LTE-A/MuLTEfire networks, the term evolved node B (eNB) may be generally used to describe the base stations 105, while the term UE may be generally used to describe the UEs 110. The wireless communication network 100 may be a heterogeneous technology network in which different types of eNBs provide coverage for various geographical regions. For example, each eNB or base station 105 may provide communication coverage for a macro cell, a small cell, or other types of cell.

A macro cell may generally cover a relatively large geographic area (e.g., several kilometers in radius) and may allow unrestricted access by UEs 110 with service subscriptions with the network provider.

A small cell may include a relative lower transmit-powered base station, as compared with a macro cell, that may operate in the same or different frequency bands (e.g., licensed, unlicensed, etc.) as macro cells. Small cells may include pico cells, femto cells, and micro cells according to various examples. A pico cell, for example, may cover a small geographic area and may allow unrestricted access by UEs 110 with service subscriptions with the network provider. A femto cell may also cover a small geographic area (e.g., a home) and may provide restricted access and/or unrestricted access by UEs 110 having an association with the femto cell (e.g., in the restricted access case, UEs 110 in a closed subscriber group (CSG) of the base station 105, which may include UEs 110 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The communication networks that may accommodate some of the various disclosed examples may be packet-based networks that operate according to a layered protocol stack and data in the user plane may be based on the IP. A user plane protocol stack (e.g., packet data convergence protocol (PDCP), radio link control (RLC), MAC, etc.), may perform packet segmentation and reassembly to communicate over logical channels. For example, a MAC layer may perform priority handling and multiplexing of logical channels into transport channels. The MAC layer may also use hybrid automatic repeat/request (HARQ) to provide retransmission at the MAC layer to improve link efficiency. In the control plane, the RRC protocol layer may provide establishment, configuration, and maintenance of an RRC connection between a UE 110 and the base stations 105. The RRC protocol layer may also be used for the EPC 180 or the 5GC 190 support of radio bearers for the user plane data. At the physical (PHY) layer, the transport channels may be mapped to physical channels.

The UEs 110 may be dispersed throughout the wireless communication network 100, and each UE 110 may be stationary or mobile. A UE 110 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 110 may be a cellular phone, a smart phone, a personal digital assistant (PDA), a wireless modem, a wireless communication device, a handheld device, a tablet computer, a laptop computer, a cordless phone, a smart watch, a wireless local loop (WLL) station, an entertainment device, a vehicular component, a customer premises equipment (CPE), or any device capable of communicating in wireless communication network 100. Some non-limiting examples of UEs 110 may include a session initiation protocol (SIP) phone, a satellite radio, a global positioning system, a multimedia device, a video device, a digital audio player (e.g., MP3 player), a camera, a game console, a smart device, a wearable device, a vehicle, an electric meter, a gas pump, a large or small kitchen appliance, a healthcare device, an implant, a sensor/actuator, a display, or any other similar functioning device. Additionally, a UE 110 may be Internet of Things (IoT) and/or machine-to-machine (M2M) type of device, e.g., a low power, low data rate (relative to a wireless phone, for example) type of device, that may in some aspects communicate infrequently with wireless communication network 100 or other UEs. Some of the UEs 110 may be referred to as IoT devices (e.g., parking meter, gas pump, toaster, vehicles, heart monitor, etc.). A UE 110 may be able to communicate with various types of base stations 105 and network equipment including macro eNBs, small cell eNBs, macro gNBs, small cell gNBs, relay base stations, and the like.

UE 110 may be configured to establish one or more wireless communication links 135 with one or more base stations 105. The wireless communication links 135 shown in wireless communication network 100 may carry uplink (UL) transmissions from a UE 110 to a base station 105, or downlink (DL) transmissions, from a base station 105 to a UE 110. The downlink transmissions may also be called forward link transmissions while the uplink transmissions may also be called reverse link transmissions. Each wireless communication link 135 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. In an aspect, the wireless communication links 135 may transmit bidirectional communications using FDD (e.g., using paired spectrum resources) or TDD operation (e.g., using unpaired spectrum resources). Frame structures may be defined for FDD (e.g., frame structure type 1) and TDD (e.g., frame structure type 2). Moreover, in some aspects, the wireless communication links 135 may represent one or more broadcast channels.

Certain UEs 110 may communicate with each other using a V2V communication link 126. The V2V communication link 126 may use the DL/UL WWAN spectrum. The V2V communication link 126 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). V2V communication may be through a variety of wireless V2V communications systems, such as for example, FlashLinQ, WiMedia, Bluetooth, ZigBee, Wi-Fi based on the IEEE 802.11 standard, LTE, or NR.

In certain aspects, one or more UEs 110 may be configured for cellular vehicle-to-everything (CV2X) communications between UEs 110. The UEs 110 may include various devices related to vehicles and transportation. For example, the UEs 110 may include vehicles, devices within vehicles, and transportation infrastructure such as roadside devices, tolling stations, fuel supplies, or any other device that that may communicate with a vehicle. A UE 110 may act as either a source device or a destination device for CV2X communication. A source UE 110 may advertise CV2X services supported by the source UE 110. A destination UE 110 may discover CV2X services supported by the source UE 110. Moreover, a UE 110 may act as both a source UE and a destination UE. For example, a vehicle may act as a source to provide speed and braking updates to surrounding vehicles and act as a destination to communicate with a tolling station. Accordingly, a single UE 110 may include both a host discovery component and a client discovery component.

In some aspects of the wireless communication network 100, base stations 105 or UEs 110 may include multiple antennas for employing antenna diversity schemes to improve communication quality and reliability between base stations 105 and UEs 110. Additionally or alternatively, base stations 105 or UEs 110 may employ MIMO techniques that may take advantage of multi-path environments to transmit multiple spatial layers carrying the same or different coded data.

Wireless communication network 100 may support operation on multiple cells or carriers, such as carrier aggregation (CA) or multi-carrier operation. The terms “carrier,” “component carrier,” “cell,” and “channel” may be used interchangeably herein. A UE 110 may be configured with multiple downlink component carriers (CCs) and one or more uplink CCs for carrier aggregation. Carrier aggregation may be used with both FDD and TDD component carriers. The communication links 135 may use multiple-input and multiple-output (MIMO) antenna technology, including spatial multiplexing, beamforming, and/or transmit diversity. The base stations 105 and/or UEs 110 may use spectrum up to Y MHz (e.g., 5, 10, 15, 20, 30, 50, 100, 200, 400, etc., MHz) bandwidth per carrier allocated in a carrier aggregation of up to a total of Yx MHz (x=number of component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 110 may communicate with each other using device-to-device (D2D) communication link 138. The D2D communication link 138 may use the DL/UL WWAN spectrum. The D2D communication link 138 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications network 100 may further include base stations 105 operating according to Wi-Fi technology, e.g., Wi-Fi access points, in communication with UEs 110 operating according to Wi-Fi technology, e.g., Wi-Fi stations (STAs) via communication links in an unlicensed frequency spectrum (e.g., 5 GHz). When communicating in an unlicensed frequency spectrum, the STAs and AP may perform a clear channel assessment (CCA) or listen before talk (LBT) procedure prior to communicating in order to determine whether the channel is available.

The small cell may operate in a licensed and/or an unlicensed frequency spectrum. When operating in an unlicensed frequency spectrum, the small cell may employ NR and use the same 5 GHz unlicensed frequency spectrum as used by the Wi-Fi AP. The small cell, employing NR in an unlicensed frequency spectrum, may boost coverage to and/or increase capacity of the access network.

Some base stations 105, such as a gNB may operate in a traditional sub 6 GHz spectrum, in millimeter wave (mmW) frequencies and/or near mmW frequencies in communication with the UE 110. When the gNB, such as a base station 105 operates in mmW or near mmW frequencies, the base station 105 may be referred to as an mmW base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, and may also be referred to as centimeter wave. Communications using the mmW and/or near mmW radio frequency band has extremely high path loss and a short range. The mmW base station 105 may utilize beamforming with the UEs 110 in their transmissions to compensate for the extremely high path loss and short range.

In a non-limiting example, the EPC 180 may include a Mobility Management Entity (MME) 181, other MMEs 182, a Serving Gateway 183, a Multimedia Broadcast Multicast Service (MBMS) Gateway 184, a Broadcast Multicast Service Center (BM-SC) 185, and a Packet Data Network (PDN) Gateway 186. The MME 181 may be in communication with a Home Subscriber Server (HSS) 187. The MME 181 is the control node that processes the signaling between the UEs 110 and the EPC 180. Generally, the MME 181 provides bearer and connection management. All user Internet protocol (IP) packets are transferred through the Serving Gateway 183, which itself is connected to the PDN Gateway 186. The PDN Gateway 186 provides UE IP address allocation as well as other functions. The PDN Gateway 186 and the BM-SC 185 are connected to the IP Services 188. The IP Services 188 may include the Internet, an intranet, an IP Multimedia Subsystem (IMS), a PS Streaming Service, and/or other IP services. The BM-SC 185 may provide functions for MBMS user service provisioning and delivery. The BM-SC 185 may serve as an entry point for content provider MBMS transmission, may be used to authorize and initiate MBMS Bearer Services within a public land mobile network (PLMN), and may be used to schedule MBMS transmissions. The MBMS Gateway 184 may be used to distribute MBMS traffic to the base stations 105 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 110 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

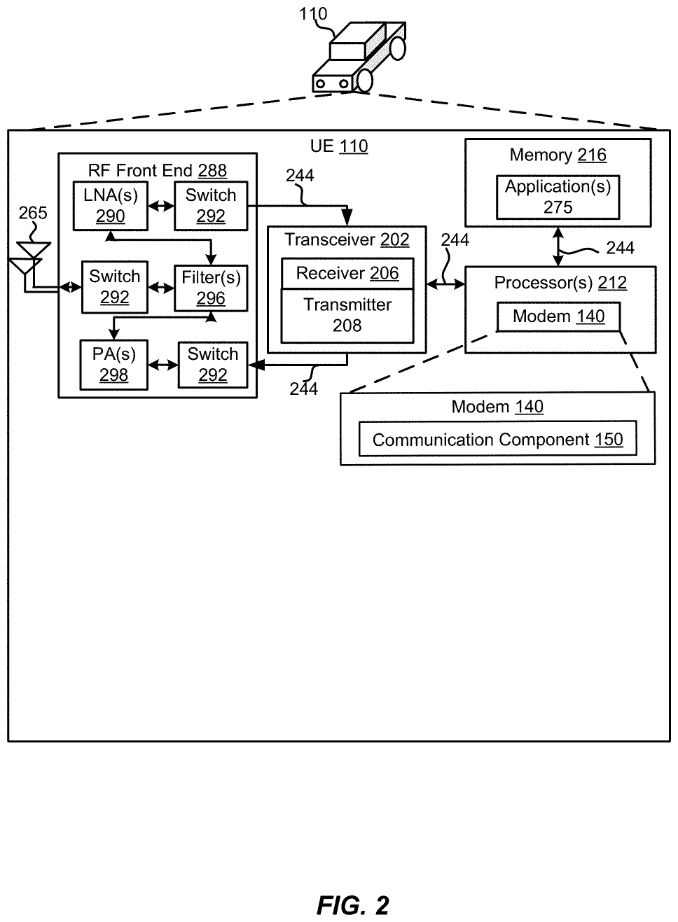

Referring to FIG. 2, one example of an implementation of the UE 110 may include a variety of components, some of which have already been described above, but including components such as one or more processors 212 and memory 216 and transceiver 202 in communication via one or more buses 244, which may operate in conjunction with the modem 140 and the communication component 150 to enable one or more of the functions described herein related to communicating with the base station 105. Further, the one or more processors 212, modem 140, memory 216, transceiver 202, RF front end 288 and one or more antennas 265, may be configured to support voice and/or data calls (simultaneously or non-simultaneously) in one or more radio access technologies. The one or more antennas 265 may include stand-alone antennas and/or antenna arrays.

In an aspect, the one or more processors 212 may include the modem 140 that uses one or more modem processors. The various functions related to the communication component 150 may be included in the modem 140 and/or processors 212 and, in an aspect, may be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or the modem 140 associated with the communication component 150 may be performed by transceiver 202.

Also, memory 216 may be configured to store data used herein and/or local versions of applications 275 for the communication component 150 and/or one or more subcomponents of the communication component 150 being executed by at least one processor 212. Memory 216 may include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining the communication component 150 and/or one or more of its subcomponents, and/or data associated therewith, when UE 110 is operating at least one processor 212 to execute the communication component 150 and/or one or more of its subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 105. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 110 may include RF front end 288, which may operate in communication with one or more antennas 265 and transceiver 202 for receiving and transmitting radio transmissions, for example, wireless communications transmitted by at least one base station 105 or wireless transmissions transmitted by UE 110. RF front end 288 may be coupled with one or more antennas 265 and may include one or more low-noise amplifiers (LNAs) 290, one or more switches 292, one or more power amplifiers (PAs) 298, and one or more filters 296 for transmitting and receiving RF signals.

In an aspect, LNA 290 may amplify a received signal at a desired output level. In an aspect, each LNA 290 may have a specified minimum and maximum gain values. In an aspect, RF front end 288 may use one or more switches 292 to select a particular LNA 290 and the specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and the specified gain value based on a desired gain value for a particular application.

Also, for example, one or more filters 296 may be used by RF front end 288 to filter a received signal to obtain an input RF signal. Similarly, in an aspect, for example, a respective filter 296 may be used to filter an output from a respective PA 298 to produce an output signal for transmission. In an aspect, each filter 296 may be coupled with a specific LNA 290 and/or PA 298. In an aspect, RF front end 288 may use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 110 may communicate with, for example, one or more base stations 105 or one or more cells associated with one or more base stations 105. In an aspect, for example, the modem 140 may configure transceiver 202 to operate at a specified frequency and power level based on the UE configuration of the UE 110 and the communication protocol used by the modem 140.

In an aspect, the modem 140 may be a multiband-multimode modem, which may process digital data and communicate with transceiver 202 such that the digital data is sent and received using transceiver 202. In an aspect, the modem 140 may be multiband and be configured to support multiple frequency bands for a specific communications protocol. In an aspect, the modem 140 may be multimode and be configured to support multiple operating networks and communications protocols. In an aspect, the modem 140 may control one or more components of UE 110 (e.g., RF front end 288, transceiver 202) to enable transmission and/or reception of signals from the network based on a specified modem configuration. In an aspect, the modem configuration may be based on the mode of the modem and the frequency band in use. In another aspect, the modem configuration may be based on UE configuration information associated with UE 110 as provided by the network during cell selection and/or cell reselection.

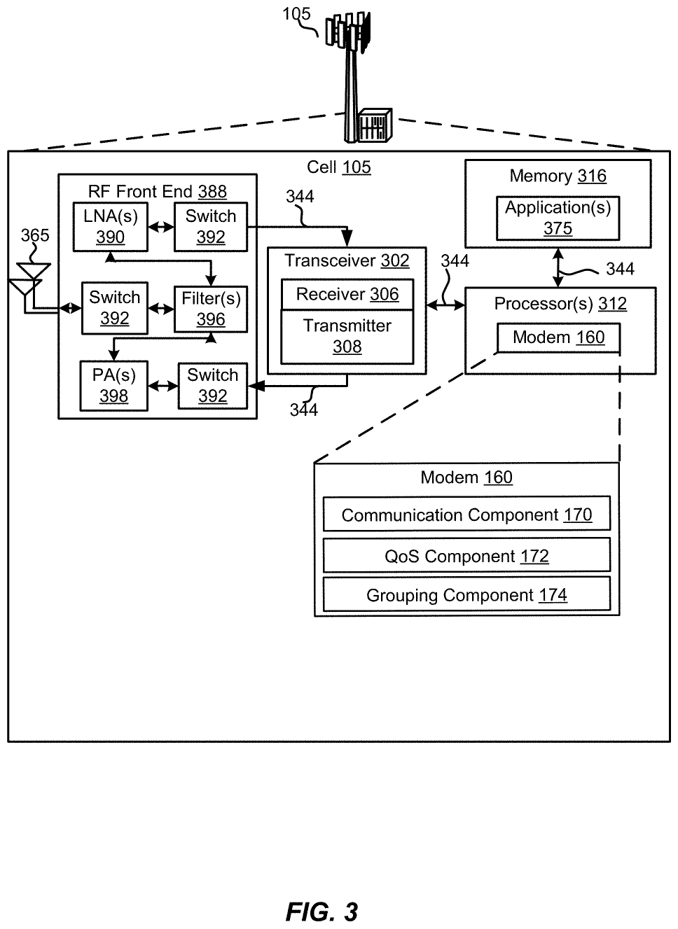

Referring to FIG. 3, one example of an implementation of base station 105 may include a variety of components, some of which have already been described above, but including components such as one or more processors 312 and memory 316 and transceiver 302 in communication via one or more buses 344, which may operate in conjunction with the modem 160, the communication component 170, the QoS component 172, and/or the grouping component 174 to enable one or more of the functions described herein related to communicating with the UE 110. Further, the one or more processors 312, modem 160, memory 316, transceiver 302, RF front end 388 and one or more antennas 365, may be configured to support voice and/or data calls (simultaneously or non-simultaneously) in one or more radio access technologies. The one or more antennas 365 may include stand-alone antennas and/or antenna arrays.

In an aspect, the one or more processors 312 may include the modem 160 that uses one or more modem processors. The various functions related to the communication component 170, the communication component 170, the QoS component 172, and/or the grouping component 174 may be included in the modem 160 and/or processors 312 and, in an aspect, may be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or the modem 160 associated with the communication component 170 may be performed by transceiver 302.

Also, memory 316 may be configured to store data used herein and/or local versions of applications 375 for the communication component 170, the QoS component 172, and/or the grouping component 174 and/or one or more subcomponents being executed by at least one processor 312. Memory 316 may include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining the communication component 170, the QoS component 172, and/or the grouping component 174 and/or one or more of the subcomponents, and/or data associated therewith, when base station 105 is operating at least one processor 312 to execute the communication component 170, the QoS component 172, and/or the grouping component 174 and/or one or more of their subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one UE 110. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, the base station 105 may include RF front end 388, which may operate in communication with one or more antennas 365 and transceiver 302 for receiving and transmitting radio transmissions, for example, wireless communications transmitted by at least one base station 105 or wireless transmissions transmitted by UE 110. RF front end 388 may be coupled with one or more antennas 365 and may include one or more low-noise amplifiers (LNAs) 390, one or more switches 392, one or more power amplifiers (PAs) 398, and one or more filters 396 for transmitting and receiving RF signals.

In an aspect, LNA 390 may amplify a received signal at a desired output level. In an aspect, each LNA 390 may have a specified minimum and maximum gain values. In an aspect, RF front end 388 may use one or more switches 392 to select a particular LNA 390 and the specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and the specified gain value based on a desired gain value for a particular application.

Also, for example, one or more filters 396 may be used by RF front end 388 to filter a received signal to obtain an input RF signal. Similarly, in an aspect, for example, a respective filter 396 may be used to filter an output from a respective PA 398 to produce an output signal for transmission. In an aspect, each filter 396 may be coupled with a specific LNA 390 and/or PA 398. In an aspect, RF front end 388 may use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that base station 105 may communicate with, for example, the UE 110. In an aspect, for example, the modem 160 may configure transceiver 302 to operate at a specified frequency and power level based on the base station configuration of the base station 105 and the communication protocol used by the modem 160.

In an aspect, the modem 160 may be a multiband-multimode modem, which may process digital data and communicate with transceiver 302 such that the digital data is sent and received using transceiver 302. In an aspect, the modem 160 may be multiband and be configured to support multiple frequency bands for a specific communications protocol. In an aspect, the modem 140 may be multimode and be configured to support multiple operating networks and communications protocols. In an aspect, the modem 160 may control one or more components of UE 110 (e.g., RF front end 388, transceiver 302) to enable transmission and/or reception of signals from the network based on a specified modem configuration. In an aspect, the modem configuration may be based on the mode of the modem and the frequency band in use. In another aspect, the modem configuration may be based on base station configuration information associated with base station 105.

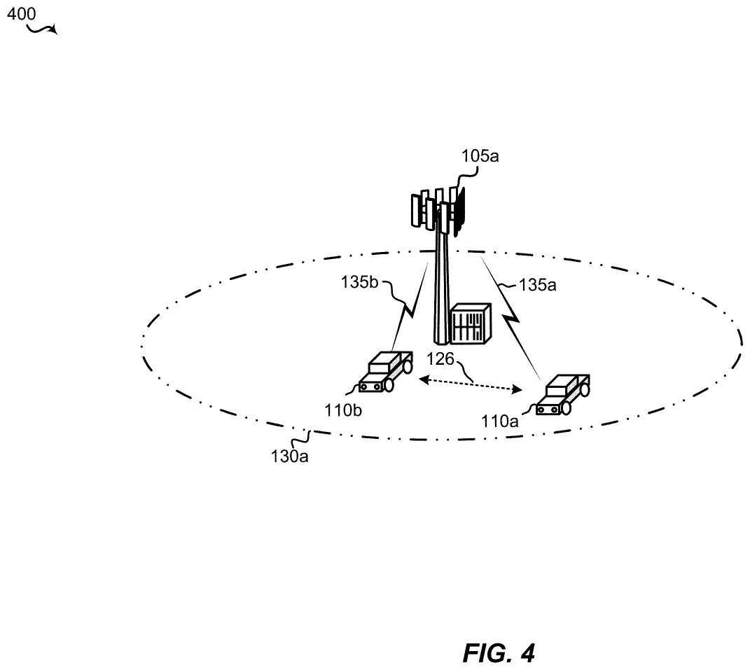

Referring to FIG. 4, an example of an environment 400 for unicast communication may include a first gNB 105a that serves a first cell having a coverage area 130a. In some examples, the first cell may include more than one neighboring cell. In some implementations, a first UE 110a may transmit sidelink UE information to the first gNB 105a (i.e., serving cell) via the first wireless communication link 135a to initiate a V2V communication session with the second UE 110b. The sidelink UE information may include one or more of L2 IDs of the first UE 110a and/or the second UE 110b, a bearer ID indicating the Quality of Service for the requested sidelink communication, physical IDs (e.g., MAC address) of the first UE 110a and/or the second UE 110b, and/or other identifiers related to the first UE 110a, the second UE 110b, or the sidelink communication. In some examples, the sidelink UE information may include a bearer group ID indicating one or more bearer IDs sharing the same QoS profile. The sidelink UE information may also include a request to establish a V2V communication link 126 with the second UE 110b. In some examples, the QoS profile may include parameters such as packet error/loss rates, packet delay budgets, peak data rates, spectral efficiencies, jitter, and other parameters that measure the quality of wireless transmission. The QoS profile may include the minimal performance values for the one or more parameters. The QoS profile may be different for different services. In some implementations, the first UE 110a and the second UE 110b may be vehicles capable of CV2X communication.

In some implementations, the sidelink UE information may include identification information relating to the first UE 110a and the second UE 110b, and the QoS profile for the transmission. In certain examples, the sidelink UE information may include the L2 ID of the first UE 110a, the L2 ID of the second UE 110b, and a bearer ID. The bearer ID may indicate the QoS for the requested sidelink communication. In other examples, the sidelink UE information may include the L2 ID of the first UE 110a, the destination index (mapped from the L2 ID of the second UE 110b), and the bearer ID. In some examples, the sidelink UE information may include the physical ID of the first UE 110a, the physical ID of the second UE 110b, and the bearer ID.

Still referring to FIG. 4, the first gNB 105a may transmit RRC connection configuration information to the first UE 110a in response to the sidelink UE information. The RRC connection configuration information may include configuration details for signaling radio bearer, physical uplink shared channel (PUSCH), physical uplink control channel (PUCCH), and physical downlink shared channel (PDSCH) information, channel quality indicator (CQI) reports, sounding reference signals, antenna configurations, scheduling requests, and other information used by the first UE 110a to establish the V2V communication link 126.

In certain implementations, the first gNB 105a may generate a mapping between the sidelink bearers and the logical channel groups based on the QoS profile. Multiple sidelink bearers with the same or similar QoS requirements may be categorized under the same LCG. When responding with the RRC connection configuration information, the network may provide dedicated RNTI for V2V unicast for each destination. In some examples, the first gNB 105 may generate a link ID for the SRC/DST communication pair to represent the unicast connection.

Still referring to FIG. 4, the first UE 110a may send a BSR to the first gNB 105a to request resources. The amount of resource elements in the requested resources may be determined by the amount of data in the TX buffer of the first UE 110a, the available resources in the serving cell of the first gNB 105a, the types of data to be transmitted, or other relevant criteria.

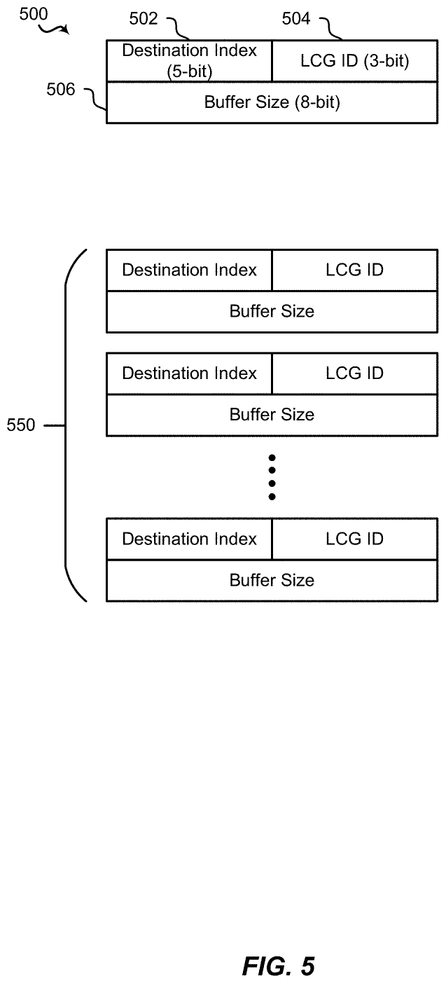

Turning now to FIG. 5, in certain aspects, an example of a BSR 500 may include a destination index field 502, a LCG ID field 504, and a buffer size field 506. The destination index field 502 may include 5 bits and identifies the ProSe destination. The value of the destination index field 502 may be the index of the destination UE (e.g., the second UE 110b) or the destination service as identified by the PSID. The LCG ID field 504 may include 3 bits and identifies the group of logical channel(s) which the buffer status of the first UE 110a is being reported. The buffer size field 506 may include 8 bits and identifies the number of data available of a LCG of a ProSe destination. The amount of data may be indicated in bytes. In other implementations, the number of bits in the destination index field 502, the LCG ID field 504, and/or the buffer size field 506 may be different than the BSR 500. During NR sidelink BSR transmission, a chain 550 (two or more) of 2-octet BSRs may be implemented to represent all LCGs having data available for transmission.

Referring back to FIG. 4, in response to the BSR, the first gNB 105a may transmit a sidelink grant to the first UE 110a to allocate the first resources to the first UE 110a and designate the QoS profile. The sidelink grant may indicate the first UE 110a and the second UE 110b, and the sidelink bearer ID (or the sidelink bearer group ID) to notify the first UE 110a the allotted QoS profile. The downlink control information (DCI) format may accommodate the sidelink grant for unicast. In one implementation, the sidelink grant message be scrambled with the dedicated RNTI allocated for a particular pair of SRC/DST communication pair, such as the first UE 110a and the second UE 110b. In another implementation, the communication pair and the bearer ID/bearer group ID allocated for unicast may be included as part of the grant message.

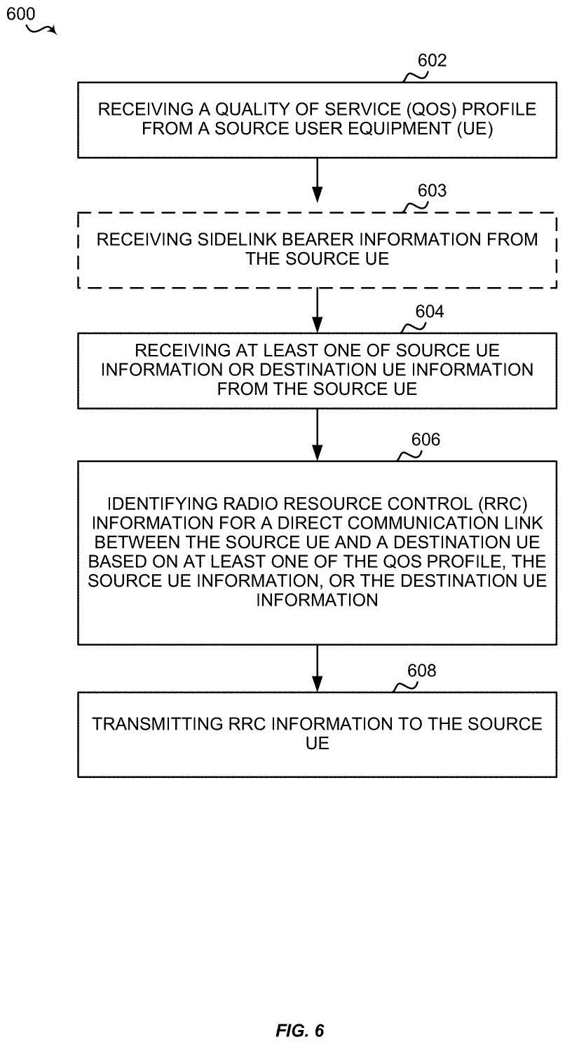

Turning now to FIG. 6, the communication component 170, the QoS component 172, the grouping component 174, the one or more processors 312, the modem 160, and/or the gNB 105a may perform an example of a method 600 of transmitting RRC information to the UE 110.

At block 602, the method 600 may receive a quality of service profile from a source user equipment. For example, the communication component 170 of a BS, such as the gNB 105a, may receive a QoS profile from the first UE 110a regarding the requested resources for the V2V communication with the second UE 110b. The one or more antennas 365 of the gNB 105a may receive electro-magnetic signals associated with the QoS profile. The RF front end 388 of the gNB 105a may filter, amplify, and/or extract electrical signals carried by the electro-magnetic signals. The transceiver 302 or the receiver 306 of the gNB 105a may digitize and convert the electrical signals into data, such as the QoS profile, and send to the communication component 170 of the gNB 105a. Thus, the communication component 170, the transceiver 302, the transmitter 308, the RF front end 388, the one or more antennas 365, the modem 160, the one or more processors 312, and/or the first gNB 105a or one of its subcomponents may define the means for receiving the QoS profile. Additional details regarding receiving the QoS profile are discussed above with reference to FIGS. 4 and 5.

At block 603, the method 600 may optionally receive sidelink bearer information from the source UE. For example, the communication component 170 of a BS, such as the gNB 105a, may optionally receive sidelink bearer information, such as the bearer ID, from the first UE 110a. The one or more antennas 365 of the gNB 105a may receive electro-magnetic signals associated with the sidelink bearer information. The RF front end 388 of the gNB 105a may filter, amplify, and/or extract electrical signals carried by the electro-magnetic signals. The transceiver 302 or the receiver 306 of the gNB 105a may digitize and convert the electrical signals into data, such as the sidelink bearer information, and send to the communication component 170 of the gNB 105a. Thus, the communication component 170, the transceiver 302, the transmitter 308, the RF front end 388, the one or more antennas 365, the modem 160, the one or more processors 312, and/or the first gNB 105a or one of its subcomponents may define the means for receiving the sidelink bearer information. Additional details regarding receiving the sidelink bearer information are discussed above with reference to FIGS. 4 and 5.

At block 604, the method 600 may receive at least one of source UE information or destination UE information from the source UE. For example, the communication component 170 of a BS, such as the gNB 105a, may receive the L2 ID of the first UE 110a and/or the L2 ID of the second UE 110b from the first UE 110a. In alternative implementations, the communication component 170 may receive source and destination UE information having the link ID for the first UE 110a and the second UE 110b, or the physical IDs (e.g., MAC addresses) of the first UE 110a and the second UE 110b. The one or more antennas 365 of the gNB 105a may receive electro-magnetic signals associated with the source UE information and destination UE information. The RF front end 388 of the gNB 105a may filter, amplify, and/or extract electrical signals carried by the electro-magnetic signals. The transceiver 302 or the receiver 306 of the gNB 105a may digitize and convert the electrical signals into data, such as the source UE information and destination UE information, and send to the communication component 170 of the gNB 105a. Thus, the communication component 170, the transceiver 302, the transmitter 308, the RF front end 388, the one or more antennas 365, the modem 160, the one or more processors 312, and/or the first gNB 105a or one of its subcomponents may define the means for receiving the source UE information and destination UE information. Additional details regarding receiving the source UE information and destination UE information are discussed above with reference to FIGS. 4 and 5.

At block 606, the method 600 may identify RRC information for a direct communication link between the source UE and the destination UE based on at least one of the QoS profile, and the UE information. For example, the QoS component 172 and/or the grouping component 174 of a BS, such as the gNB 105a, may identify RRC information based on the QoS profile and the L2 IDs of the first UE 110a and the second UE 110b. In certain examples, the grouping component 174 may generate a link ID for the first UE 110a and the second UE 110b pair. Thus, the QoS component 172, the grouping component 174, the modem 160, the one or more processors 312, and/or the first gNB 105a or one of its subcomponents may define the means for identifying RRC information for a direct communication link between the source UE and the destination UE based on at least one of the QoS profile. Additional details regarding identifying RRC information for a direct communication link between the source UE and the destination UE based on at least one of the QoS profile are discussed above with reference to FIGS. 4 and 5.

At block 608, the method 600 may transmit the RRC information to the source UE. For example, the communication component 170 of a BS, such as the gNB 105a, may transmit the RRC information to the first UE 110a. The RRC information may include resources allocated for the V2V communication between the first UE 110a and the second UE110b at a given QoS. The communication component 170 of the gNB 105a may send the RRC information to the transceiver 302 or the transmitter 308 of the gNB 105a. The transceiver 302 or the transmitter 308 may convert the data into electrical signals. The RF front end 388 may filter and/or amplify the electrical signals into the electro-magnetic signals. The one or more antennas 365 of the gNB 105a may transmit the electro-magnetic signals associated with the RRC information. Thus, the communication component 170, the transceiver 302, the transmitter 308, the RF front end 388, the one or more antennas 365, the modem 160, the one or more processors 312, and/or the first gNB 105a or one of its subcomponents may define the means for transmitting the RRC information. Additional details regarding transmitting the RRC information are discussed above with reference to FIGS. 4 and 5.

In some implementations, the gNB 105a may map the sidelink bearer ID to a LCG based on the QoS profile. In other implementations, the gNB 105a may generate a link ID based on the source UE information, the destination UE information, and the QoS profile. In certain implementations, the gNB 105a may receive a buffer status report from the first UE 110a for requesting resources and transmit the RRC information including at least a link ID, a bearer ID, or a dedicated radio network temporary ID. The buffer status report may include a destination index, a LCG ID, and/or a buffer size. In another implementation, the gNB 105a may receive a plurality of buffer status reports each having a different logical channel group ID.

Certain implementations of the present disclosure may include any of the method above, wherein the QoS profile includes information relating to at least one of a packet error/loss rate, a packet delay budget, a peak data rate, a spectral efficiency, or a jitter value.

Certain implementations of the present disclosure may include any of the method above, wherein the QoS profile is associated with a particular sidelink bearer information.

Certain implementations of the present disclosure may include any of the method above, wherein the source UE information includes a source UE layer-2 (L2) identification (ID) or a physical address of the source UE and the destination UE information includes a destination UE L2 ID, a physical address of the destination UE, or a destination index.

Certain implementations of the present disclosure may include any of the method above, further comprising receiving sidelink bearer information from the source UE, wherein the sidelink bearer information includes a sidelink bearer ID.

Certain implementations of the present disclosure may include any of the method above, wherein the RRC information further comprises a mapping from the sidelink bearer ID to a logical channel group based on the QoS profile.

Certain implementations of the present disclosure may include any of the method above, further comprising generating a link ID based on the source UE information, the destination UE information, and the QoS profile.

Certain implementations of the present disclosure may include any of the method above, further comprising receiving a buffer status report from the source UE for requesting resources, wherein the buffer status report includes a destination index, a logical channel group ID, and a buffer size.

Certain implementations of the present disclosure may include any of the method above, wherein the RRC information includes at least a link ID, a bearer ID, or a dedicated radio network temporary ID.

Certain implementations of the present disclosure may include any of the method above, further comprising receiving a plurality of buffer status reports each having a different logical channel group ID from a plurality of UEs.

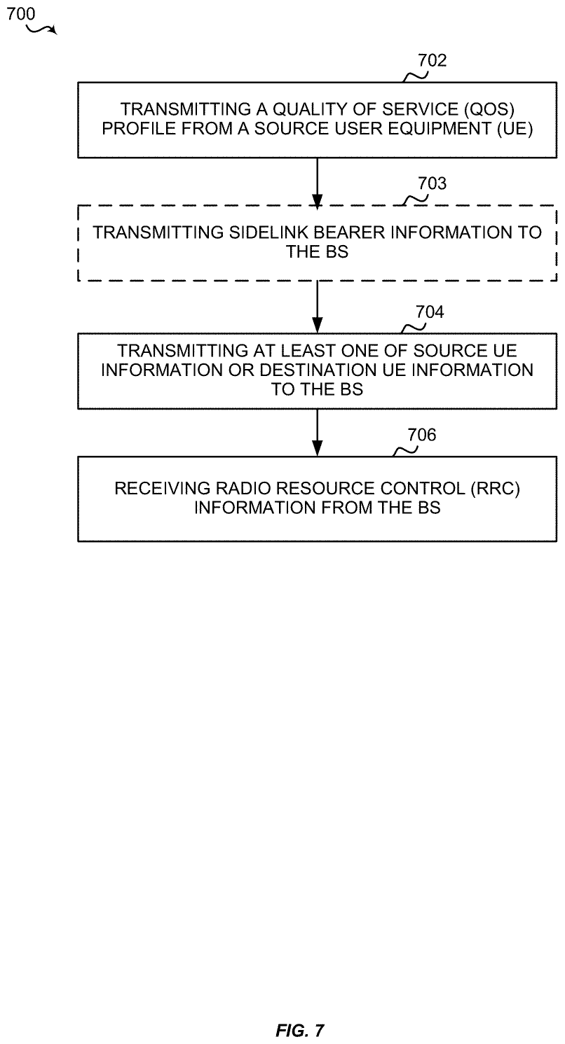

Turning now to FIG. 7, the communication component 150, the one or more processors 212, the modem 140, and/or the first UE 110a may perform an example of a method 700 of receiving RRC information from the gNB 105a.

At block 702, the method 700 may transmit a QoS profile to the base station. For example, the communication component 150 of the first UE 110a may transmit a QoS profile to the gNB 105a. The communication component 150 of the first UE 110a may send the QoS profile to the transceiver 202 or the transmitter 208 of the first UE 110a. The transceiver 202 or the transmitter 208 may convert the data into electrical signals. The RF front end 288 may filter and/or amplify the electrical signals into the electro-magnetic signals. The one or more antennas 265 of the first UE 110a may transmit the electro-magnetic signals associated with the QoS profile. Thus, the communication component 150, the transceiver 202, the transmitter 208, the RF front end 288, the one or more antennas 265, the modem 140, the one or more processors 212, and/or the first UE 110a or one of its subcomponents may define the means for transmitting the QoS profile. Additional details regarding transmitting the QoS profile are discussed above with reference to FIGS. 4 and 5.

At block 703, the method 700 may optionally transmit sidelink bearer information to the BS. For example, the communication component 150 of the first UE 110a may optionally transmit the sidelink bearer information, such as the bearer ID, to the gNB 105a. The communication component 150 of the first UE 110a may optionally send the sidelink bearer information to the transceiver 202 or the transmitter 208 of the first UE 110a. The transceiver 202 or the transmitter 208 may convert the data into electrical signals. The RF front end 288 may filter and/or amplify the electrical signals into the electro-magnetic signals. The one or more antennas 265 of the first UE 110a may transmit the electro-magnetic signals associated with the sidelink bearer information. Thus, the communication component 150, the transceiver 202, the transmitter 208, the RF front end 288, the one or more antennas 265, the modem 140, the one or more processors 212, and/or the first UE 110a or one of its subcomponents may define the means for transmitting the sidelink bearer information. Additional details regarding transmitting the sidelink bearer information are discussed above with reference to FIGS. 4 and 5.

At block 704, the method 700 may transmit at least one of source UE information or destination UE information to the BS. For example, the communication component 150 of the first UE 110a may transmit the L2 ID of the first UE 110a and/or the L2 ID of the second UE 110b from the first UE 110a to the gNB 105a. In alternative implementations, the communication component 150 of the first UE 110a may transmit the link ID for the first UE 110a and the second UE 110b, or the physical IDs (e.g., MAC addresses) of the first UE 110a and the second UE 110b. The communication component 150 of the first UE 110a may send the source UE information and destination UE information to the transceiver 202 or the transmitter 208 of the first UE 110a. The transceiver 202 or the transmitter 208 may convert the data into electrical signals. The RF front end 288 may filter and/or amplify the electrical signals into the electro-magnetic signals. The one or more antennas 265 of the first UE 110a may transmit the electro-magnetic signals associated with the source UE information and destination UE information. Thus, the communication component 150, the transceiver 202, the transmitter 208, the RF front end 288, the one or more antennas 265, the modem 140, the one or more processors 212, and/or the first UE 110a or one of its subcomponents may define the means for transmitting the source UE information and destination UE information. Additional details regarding transmitting the source UE information and destination UE information are discussed above with reference to FIGS. 4 and 5.

At block 706, the method 700 may receive the RRC information. For example, the communication component 150 of the first UE 110a may receive the RRC information, which may include resources allocated for the V2V communication between the first UE 110a and the second UE110b at a given QoS. The one or more antennas 265 of the first UE 110a may receive electro-magnetic signals associated with the RRC information. The RF front end 288 of the first UE 110a may filter, amplify, and/or extract electrical signals carried by the electro-magnetic signals. The transceiver 202 or the receiver 206 of the first UE 110a may digitize and convert the electrical signals into data, such as the RRC information, and send to the communication component 150 of the first UE 110a. Thus, the communication component 150, the transceiver 202, the transmitter 208, the RF front end 288, the one or more antennas 265, the modem 140, the one or more processors 212, and/or the first UE 110a or one of its subcomponents may define the means for receiving the RRC information. Additional details regarding receiving the RRC information are discussed above with reference to FIGS. 4 and 5.

Certain implementations of the present disclosure may include any of the method above, wherein the QoS profile includes information relating to at least one of a packet error/loss rate, a packet delay budget, a peak data rate, a spectral efficiency, or a jitter value.

Certain implementations of the present disclosure may include any of the method above, wherein the QoS profile is associated with a particular sidelink bearer information.

Certain implementations of the present disclosure may include any of the method above, wherein the source UE information includes a source UE layer-2 (L2) identification (ID) or a physical address of the source UE and the destination UE information includes a destination UE L2 ID, a physical address of a destination UE, or a destination index.

Certain implementations of the present disclosure may include any of the method above, further comprises transmitting sidelink bearer information to the BS, wherein the sidelink bearer information includes a sidelink bearer ID.

Certain implementations of the present disclosure may include any of the method above, wherein the RRC information further comprises a mapping from the sidelink bearer ID to a logical channel group based on the QoS profile.

Certain implementations of the present disclosure may include any of the method above, further comprises transmitting a buffer status report to the BS for requesting resources, wherein the buffer status report includes at least one of a destination index, a logical channel group ID, or a buffer size.

Certain implementations of the present disclosure may include any of the method above, wherein the RRC information includes at least a link ID, a bearer ID, or a dedicated radio network temporary ID.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description herein, however, describes an LTE/LTE-A system or 5G system for purposes of example, and LTE terminology is used in much of the description below, although the techniques may be applicable other next generation communication systems.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of wireless communication by a source user equipment (UE), comprising:
transmitting a quality of service (QoS) profile to a base station (BS);
transmitting at least one of source UE information or destination UE information to the BS; and
receiving radio resource control (RRC) information from the BS.

2. The method of claim 1, wherein the QoS profile includes information relating to at least one of a packet error/loss rate, a packet delay budget, a peak data rate, a spectral efficiency, or a jitter value.

3. The method of claim 1, wherein the QoS profile is associated with a particular sidelink bearer information.

4. The method of claim 1, wherein:
the source UE information includes a source UE layer-2 (L2) identification (ID) or a physical address of the source UE; and
the destination UE information includes a destination UE L2 ID, a physical address of a destination UE, or a destination index.

5. The method of claim 1, further comprises transmitting sidelink bearer information to the BS, wherein the sidelink bearer information includes a sidelink bearer ID.

6. The method of claim 5, wherein the RRC information further comprises a mapping from the sidelink bearer ID to a logical channel group based on the QoS profile.

7. The method of claim 1, further comprises:
transmitting a buffer status report to the BS for requesting resources, wherein the buffer status report includes at least one of a destination index, a logical channel group ID, or a buffer size.

8. A source user equipment (UE), comprising
a memory;
a transceiver; and
one or more processors operatively coupled with the memory and the transceiver, the one or more processors being configured to:
transmit, via the transceiver, a quality of service (QoS) profile to a base station (BS);
transmit, via the transceiver, at least one of source UE information or destination UE information to the BS; and
receive, via the transceiver, radio resource control (RRC) information from the BS.

9. The source UE of claim 8, wherein the QoS profile includes information relating to at least one of a packet error/loss rate, a packet delay budget, a peak data rate, a spectral efficiency, or a jitter value.

10. The source UE of claim 8, wherein the QoS profile is associated with a particular sidelink bearer information.

11. The source UE of claim 8, wherein:
the source UE information includes a source UE layer-2 (L2) identification (ID) or a physical address of the source UE; and
the destination UE information includes a destination UE L2 ID, a physical address of a destination UE, or a destination index.

12. The source UE of claim 8, wherein:
the one or more processors is further configured to transmit sidelink bearer information to the BS; and
the sidelink bearer information includes a sidelink bearer ID.

13. The source UE of claim 12, wherein the RRC information further comprises a mapping from the sidelink bearer ID to a logical channel group based on the QoS profile.

14. The source UE of claim 8, wherein the one or more processors is further configured to:
transmit, via the transceiver, a buffer status report to the BS for requesting resources, wherein the buffer status report includes at least one of a destination index, a logical channel group ID, or a buffer size.

15. A non-transitory computer-readable medium having instructions stored therein that, when executed by one or more processors of a source user equipment (UE), cause the one or more processors to:
transmit a quality of service (QoS) profile to a base station (BS);
transmit at least one of source UE information or destination UE information to the BS; and
receive radio resource control (RRC) information from the BS.

16. The non-transitory computer-readable medium of claim 15, wherein the QoS profile includes information relating to at least one of a packet error/loss rate, a packet delay budget, a peak data rate, a spectral efficiency, or a jitter value.

17. The non-transitory computer-readable medium of claim 15, wherein the QoS profile is associated with a particular sidelink bearer information.

18. The non-transitory computer-readable medium of claim 15, wherein:
the source UE information includes a source UE layer-2 (L2) identification (ID) or a physical address of the source UE; and
the destination UE information includes a destination UE L2 ID, a physical address of a destination UE, or a destination index.

19. The non-transitory computer-readable medium of claim 15, further comprises instructions stored therein that, when executed by the one or more processors of the source UE, cause the one or more processors to transmit sidelink bearer information to the BS, wherein the sidelink bearer information includes a sidelink bearer ID.

20. The non-transitory computer-readable medium of claim 19, wherein the RRC information further comprises a mapping from the sidelink bearer ID to a logical channel group based on the QoS profile.

21. The non-transitory computer-readable medium of claim 15, further comprises instructions that, when executed by the one or more processors of the source UE, cause the one or more processors to:
transmit a buffer status report to the BS for requesting resources, wherein the buffer status report includes at least one of a destination index, a logical channel group ID, or a buffer size.

22. A method of wireless communication by a base station (BS), comprising:
receiving a quality of service (QoS) profile from a source user equipment (UE);
receiving at least one of source UE information or destination UE information from the source UE;
identifying radio resource control (RRC) information for a direct communication link between the source UE and a destination UE based on at least one of the QoS profile, the source UE information, or the destination UE information; and
transmitting the RRC information to the source UE.

23. The method of claim 22, wherein the QoS profile includes information relating to at least one of a packet error/loss rate, a packet delay budget, a peak data rate, a spectral efficiency, or a jitter value.

24. The method of claim 22, wherein the QoS profile is associated with a particular sidelink bearer information.

25. The method of claim 22, wherein:
the source UE information includes a source UE layer-2 (L2) identification (ID) or a physical address of the source UE; and
the destination UE information includes a destination UE L2 ID, a physical address of the destination UE, or a destination index.

26. The method of claim 22, further comprises receiving sidelink bearer information from the source UE, wherein the sidelink bearer information includes a sidelink bearer ID.

27. The method of claim 26, wherein the RRC information further comprises a mapping from the sidelink bearer ID to a logical channel group based on the QoS profile.

28. The method of claim 22, further comprising generating a link ID based on the source UE information, the destination UE information, and the QoS profile.

29. The method of claim 22, further comprising:
receiving a buffer status report from the source UE for requesting resources, wherein the buffer status report includes a destination index, a logical channel group ID, and a buffer size.

30. The method of claim 29, further comprising:
receiving a plurality of buffer status reports each having a different logical channel group ID from a plurality of UEs.
